(19) United States
(12) Patent Application Publication
(10) Pub. No.: US 2005/0203792 A1
(43) Pub. Date: Sep. 15, 2005

(54) Systems and methods for enabling anonymous reporting of business activities

(76) Inventors: Markus C. M. Kuppe, Walldorf (DE); Dirk R. Ahlert, Muehlhausen (DE); Stephan B. Rehmann, Mosbach (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/012,655

(22) Filed: Dec. 15, 2004

Related U.S. Application Data
(60) Provisional application No. 60/529,579, filed on Dec. 16, 2003.

(51) Int. Cl. G06F 17/60

(52) U.S. Cl. 705/10

(57) ABSTRACT

Systems and methods are disclosed for providing a report. The disclosed systems and methods may include receiving, at a first server, complaint data. The complaint data may be configured to identify at least one questioned business practice. Furthermore, the disclosed systems and methods may include forwarding the complaint data from the first server to a second server. The first server may be anonymously logged-on to the second server. Moreover, the disclosed systems and methods may include providing confirmation data to a source of the complaint data. The confirmation data may be configured to indicate that the complaint data was received by the second server.

### CROSS-REFERENCE TO RELATED APPLICATION(S)

This application claims the benefit of U.S. Provisional Application No. 60/529,579, filed Dec. 16, 2003, the disclosure of which is expressly incorporated herein by reference to its entirety.

### BACKGROUND OF THE INVENTION

I. Field of the Invention

The present invention generally relates to computer-implemented reporting systems. More particularly, the invention relates to systems and methods for enabling the anonymous reporting of activities, such as irregular or questionable business activities.

II. Background Information

The Sarbanes-Oxley Act (SOA) was enacted by the U.S. Congress on Jul. 30, 2002 and applies to all companies registered with the Securities and Exchange Commission. Such a registered company is one that is traded on a stock market or exchange in the United States (e.g., NYSE, NASDAQ, etc.). SOA establishes heightened requirements in the area of corporate governance, financial disclosures, and accountability for fraud. Other countries are expected to determine the need for, and possibly also establish, guidance or requirements in this area. For example, the German government has issued a 10-Point Plan on corporate governance standards in February 2003.

Section 301 of SOA deals with complaints. Specifically, under Section 301, companies are required to enable their employees “to blow the whistle” by establishing so-called whistle-blower processes. Such processes must allow employees to submit confidential, anonymous complaints regarding activities, such as questionable accounting practices and auditing procedures.

For example, according to the wording of Section 301, companies have to ensure that each audit committee establishes procedures for: (i) the receipt, retention, and treatment of complaints received by the issuer regarding accounting, internal accounting controls, or auditing matters; and (ii) the confidential, anonymous submission by employees of the issuer of concerns regarding questionable accounting or auditing matters.

Most companies must establish such procedures by the earlier of the first annual meeting after Jan. 15, 2004 or October 2004.

Further, in the context of Section 301, protection for corporate whistle-blowers is required through a “whistler-blower protection clause.” If an anonymous whistle-blower requests protection according to this clause, he/she has to provide proof that he/she issued the complaint or concern.

Existing systems, such as corporate intranet and human resource (HR) or audit systems, do not provide a solution that offers the requisite level of anonymity or confidentiality to enable whistle-blowing procedures, such as those required by Section 301 of the SOA. There is also a need for systems and methods that enable anonymous reporting of irregular or questionable business activities, while at the same time facilitating or supporting whistle-blower protection clauses or measures.

### SUMMARY OF THE INVENTION

Consistent with embodiments of the invention, systems and methods are provided for enabling anonymous reporting of activities. Such systems and methods may enable the anonymous reporting of business activities, such as irregular accounting practices or auditing procedures. In addition, systems and methods consistent with the embodiments of the invention may include features to facilitate or support whistle-blower protection clauses. By way of example, confirmation features may be provided to enable an employee or user to establish that he/she submitted a particular complaint when requesting protection under a whistle-blower protection clause.

In one embodiment, systems and methods are provided for enabling the anonymous reporting of complaints by an employee concerning questionable business activities. Such systems and methods may be computerized. For example, consistent with an embodiment of the invention, whistle-blower processes may be implemented by combining web-based complaint forms and a work-flow system or an interactive forms framework. The anonymity of the complaint forms submitted by an employee or user may be guaranteed by combining this set-up with default log-on mechanisms via anonymous system accounts or other means. Further, employees who complete and submit complaint forms may be provided with a confirmation code or key(s) that allow them to prove authorship via known decryption techniques or means.

In another embodiment, a plurality of notification or complaint form entry screens may be provided to permit an employee or user to select a preferred reporting format or method. For example, to submit a report on a business activity, an employee or user may be permitted to select among a plurality of notification screens, including an anonymous notification screen and a notification by named user screen. Thus, consistent with embodiments of the invention, the option to report anonymously or non-anonymously may be provided to the user.

In accordance with yet another embodiment of the invention, an employee or user may submit a complaint form or report using a networked-computer device. The networked-computer device may comprise a self-service kiosk computer that is logged into an intranet or other network using an anonymous ID or account number. Additionally, or alternatively, employees may use a personal computing device that is logged into an intranet or other network server using the employee's ID or account number, with the call and submission of an employee's complaint form by the intranet server to an application server using an anonymous ID or account. Thus, a decoupling of the employee's identity or ID and complete anonymity may be provided through an intermediate component (i.e., an intranet and/or other network server).

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary system environment, consistent with an embodiment of the present invention;

FIG. 2 is a block diagram of another exemplary system environment, consistent with an embodiment of the present invention;

FIG. 3 is a flow chart of an exemplary reporting method, consistent with an embodiment of the present invention; and

FIGS. 4, 5 and 6 are screen shots illustrating exemplary data entry and response forms, consistent with embodiments of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Embodiments of the present invention are directed to systems and methods for enabling anonymous reporting of activities, such as irregular or questionable business activities. Such activities may comprise, for example, irregular accounting practices or auditing procedures. Further, systems and methods consistent with the invention may be provided to enable whistle-blower procedures, such as those required by the SOA or by other laws or regulations in the U.S. or in other countries.

Anonymous reporting systems and methods, consistent with the present invention, may be implemented for employees or other users to report activity related to a business entity. As used herein, the term “business entity” refers to any company, organization, group, agency or other entity involved in doing business. By way of example, a business entity may be a registered company that is traded on a stock market or exchange (e.g., FTSE, NYSE, NASDAQ, etc.). The reported business activity may relate to any event, practice, procedure or matter. Examples of reported business activities include, for example, irregular accounting procedures, questionable compensation or payments, inadequate auditing procedures, risk-related events, etc. The aforementioned activities are exemplary and others, business or otherwise, may be used.

Consistent with the present invention, systems and methods for providing anonymous reporting may be implemented using computerized systems, processes, and components, examples of which are presented herein with reference to the drawings. Such systems, processes and components may be implemented through any suitable combination of hardware, software, and/or firmware. Communication networks and other media may also be used to facilitate implementation of embodiments of the invention.

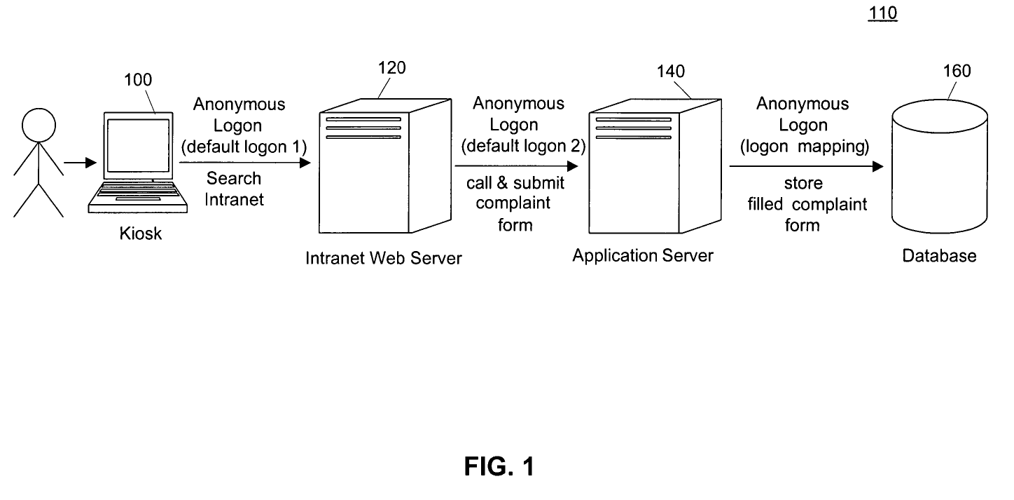

By way of example, FIG. 1 illustrates a block diagram of an exemplary system environment 110, consistent with an embodiment of the invention. The exemplary system environment 110 may be utilized for implementing reporting methods, consistent with the present invention. As shown in FIG. 1, a number of components may be provided as part of system environment 110, including a kiosk 100, an intranet web server 120, an application server 140 and a database 160. These components may communicate with one another via wired and/or wireless communication links or networks. Such communication links or networks may provide secured communication using, for example, password protected logon procedures, encrypted transmission protocols, and/or other conventional techniques. Examples of secured communication links or networks include, for instance, corporate intranets and a virtual private networks (VPNs).

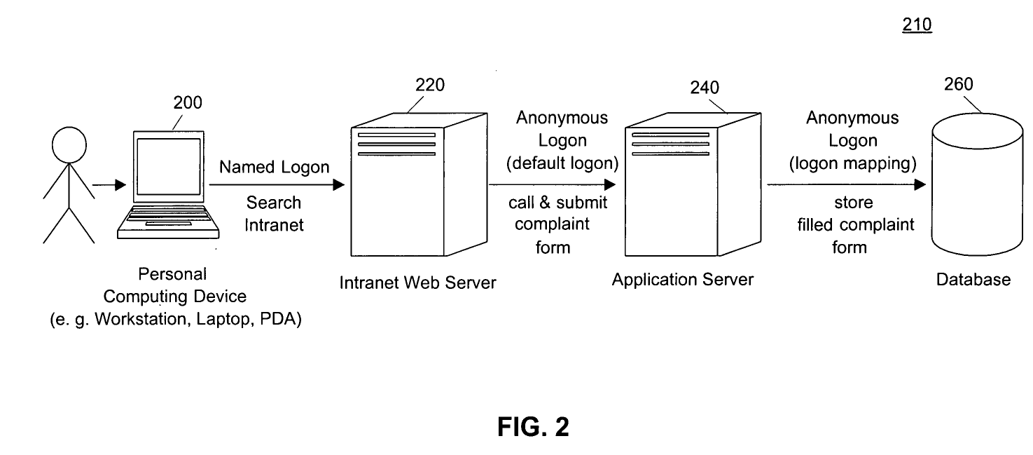

In the embodiment of FIG.1, kiosk 100 is implemented as an anonymous kiosk station to allow employees or other users to report irregular or questionable business activities. To this end, kiosk 100 may comprise a self-service kiosk computer that is logged into intranet web server 120 using an anonymous logon (e.g., a default logon with an anonymous ID or account number-“default logon 1” in FIG. 1). Intranet web server 120 may in turn be connected and logged on to application server 140. If intranet web server 120 serves as a web server for both anonymous and non-anonymous logon users (compare FIG. 1 with FIG. 2), then intranet web server 120 may itself be logged onto application server 140 using an anonymous logon. In one embodiment, a second or separate default logon may be provided with an anonymous ID or account number (“default logon 2” in FIG. 1). To facilitate an anonymous logon, application server 140 may be programmed to receive one or more username/password combinations from web server 120 or kiosk 100 that application sever 140 is to associate with anonymously logged on users. In this way, the personal identity or other identifying information associated with employees or other users may be kept from application sever 140. Once connected, intranet web server 120 may submit complaint forms or reports entered by a user at kiosk 100 to application server 140. As further disclosed herein, application server 140 may be responsible for performing logon mapping (as needed) and forwarding of complaint forms or reports to database 160 for storage and later retrieval for analysis. In another embodiment (not shown), kiosk 100 may be logged onto application server 140 directly using an anonymous logon in a similar fashion to that described above.

FIG. 2 is a block diagram of another exemplary system environment 210, consistent with an embodiment of the invention. The exemplary system environment 210 may be utilized for implementing reporting methods, consistent with the present invention. System environment 210 may include a number of components including a personal computing device 200, an intranet web server 220, an application server 240 and a database 260. As with the components of FIG. 1, the components of FIG. 2 may communicate with one another via wired and/or wireless communication links or networks. Further, such communication links or networks may provide secured communication. Examples of secured communication links or networks include, for instance, corporate intranets and a virtual private networks (VPNs).

In the embodiment of FIG. 2, personal computing device 200 may provide a user with an option to report activity using an anonymous or non-anonymous logon. In a non-anonymous session, the user may logon to intranet web server 220 using his or her user ID or account number. To this end, personal computing device 200 may comprise a personal computer, workstation, laptop, PDA, or the like with logon screens to connect to and search the intranet via server 220 for a complaint reporting page. Once connected, the user may submit data for a complaint form or report, and intranet web server 220 may log on to application server 240 to submit the complaint submitted by the user. Application server 240 may perform logon mapping (as needed) and forward the submitted complaint form or report to database 260 for storage and later retrieval for analysis. Moreover, application server 240 may be configured to anonymously communicate directly with a kiosk similar to kiosk 100 (see FIG. 1) while also being configured to anonymously communicate with intranet web server 220.

Similar to server 120 in FIG. 1, intranet web server 220 may itself be logged onto application server 240 using an anonymous logon. In one embodiment, a second or separate default logon may be provided with an anonymous ID or account number. To facilitate the anonymous logon, application server 240 may be programmed to receive one or more username/password combinations from web server 220 that application sever 240 is to associate with anonymously logged on users. In this way, the personal identity or other identifying information associated with employees or other users may be kept from application sever 240.

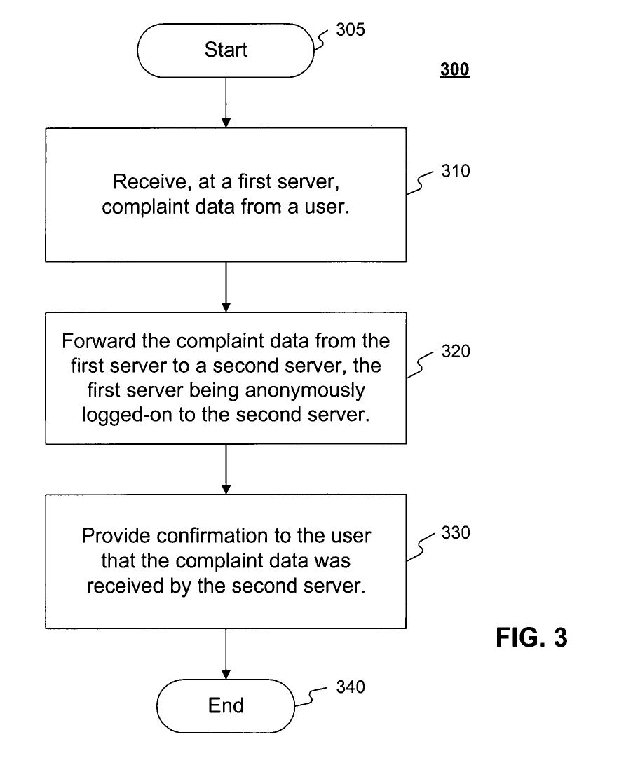

To provide a confirmation to a user or source of complaint data (as described below with respect to stage 330 of FIG. 3) exemplary system environments 110 and 210 may maintain “state” in a conventional manner. “State” may comprise the last-known or current status of an application or a process. The term “maintaining state” may refer to keeping track of a condition of the application or process. For example, the Internet or an intranet may be intrinsically stateless because each request for a new web page may be processed without any knowledge of previous pages requested. Because maintaining state may be useful, a number of techniques have been developed including, for example, server APIs such as NSAPI and ISAPI, and the use of cookies.

Consistent with embodiments of the present invention, exemplary system environments 110 and 210 and not limited to one, but may include multiple personal computing devices such as personal computing device 200 and/or multiple kiosks such as kiosk 100. Furthermore, exemplary system environment 110 may also include one or more personal computing devices such as personal computing device 200 configured to communicate anonymously with application server 140 through web server 120. Moreover, exemplary system environment 210 may also include one or more kiosks such as kiosk 100 configured to communicate anonymously with application server 240 or web server 220 or both.

Referring now to FIG. 3, a flow chart is provided of an exemplary reporting method 300, consistent with an embodiment of the invention. FIG. 3 sets forth the general stages that may be involved providing a report. The exemplary method 300 may be implemented in any computerized environment including, for example, the exemplary system environments of FIG. 1 and FIG. 2.

As shown in FIG. 3, method 300 may begin at starting block 305 and proceed to stage 310 where a first server, such as an intranet web server, may receive complaint data from a user. The complaint data may identify at least one questioned business activity. Further, the complaint data may be submitted as part of a complaint form or report. For example, consistent with an aspect of the invention, complaint forms may be provided that can be completed by employees and submitted to an administrator or auditor for review. The complaint forms may enable employees or other users to submit confidential and anonymous complaints as part of, for example, a whistle-blowing procedure. The complaint forms may be used when an employee or user witnesses any irregularities regarding, for example, financial reporting or any other accounting or auditing issues within a business entity or company.

In accordance with one embodiment, an employee or user may submit a complaint form or report using a networked-computing device. Consistent with embodiment of the invention, various arrangements are possible. For example, the networked-computing device may comprise a self-service kiosk computer that is logged onto a intranet or other network using an anonymous ID or account number. For instance, as shown in FIG. 1, kiosk computer 100 may be connected to intranet web server 120. A default logon may be provided to enable kiosk 100 to be connected to intranet server 120 under an anonymous logon. Alternatively, the employee or user may submit a complaint form from a personal computing device. For instance, as shown in the example of FIG. 2, an employee may use personal computing device 200 (e.g., PC, workstation, laptop, PDA, etc.) that is connected to intranet web server 220. In this case, the employee may logon under a non-anonymous basis using, for example, a named logon based on their employee name, account number and/or password.

From stage 310, where the first server (e.g., intranet web server 120 or 220) receives the complaint data, exemplary method 300 may advance to stage 320 where the first server may forward the complaint data to a second server, such as application server 140 or 240. To facilitate both anonymous and non-anonymous submissions, the first server may be anonymously logged onto the second server. Thus, as shown in FIGS. 1 and 2, intranet web server 120 or 140 may connect by an anonymous logon to application server 140 or 240.

In the example of FIG. 1, an employee or user can complete and submit a complaint form (such as a whistle-blower complaint form) using kiosk computer 100. Through intranet web server 120, the complaint form may be submitted to application server 140 and database 160. Thereafter, an administrator or auditor may review the complaint and open an investigation (as needed).

Additionally, or alternatively, employees may use a personal computing device that is logged onto an intranet or other network using the employee's ID or account number. For instance, as shown in the example of FIG. 2, a user at personal computing device 200 may logon to intranet web server 220 using their personal ID or account. The user can then search the intranet, locate the appropriate complaint form and complete the same. Thereafter, the completed complaint form may be submitted via the intranet server 220 to application server 240 and database 260 using a default logon and anonymous ID or account. In this way, intranet server 220 may provide a decoupling of the employee's identity or ID and anonymity before the complaint form is stored and/or reviewed by an administrator or auditor.

Consistent with embodiments of the invention, various types of complaint forms may be provided. Further, the complaint forms may be stored electronically and configured according to specific requirements, such as federal or national laws and/or internal policies. In one embodiment, the complaint forms may be searchable through intranet web server and, when accessed, displayed on a screen of a computing device (e.g., a self-service kiosk computer, a personal computer device, etc.).

Consistent with embodiments of the invention, a complaint form may be configured with a number of content fields or areas. In one embodiment, three main fields may be provided: (1) a read-only text field with instructions from an administrator or auditor (such as an accounting department); the text in this field can be modified according to specific needs; (2) a selection field with a drop-down list that helps the employee or user to select, for example, the affected company area or business unit; this list may be customizable; and (3) a description field in which the employee or user can enter and describe details related to the complaint. An appropriate action button or command (such as a “Submit” or “Send” button) may be provided below the text field to enable the user to submit the form when completed.

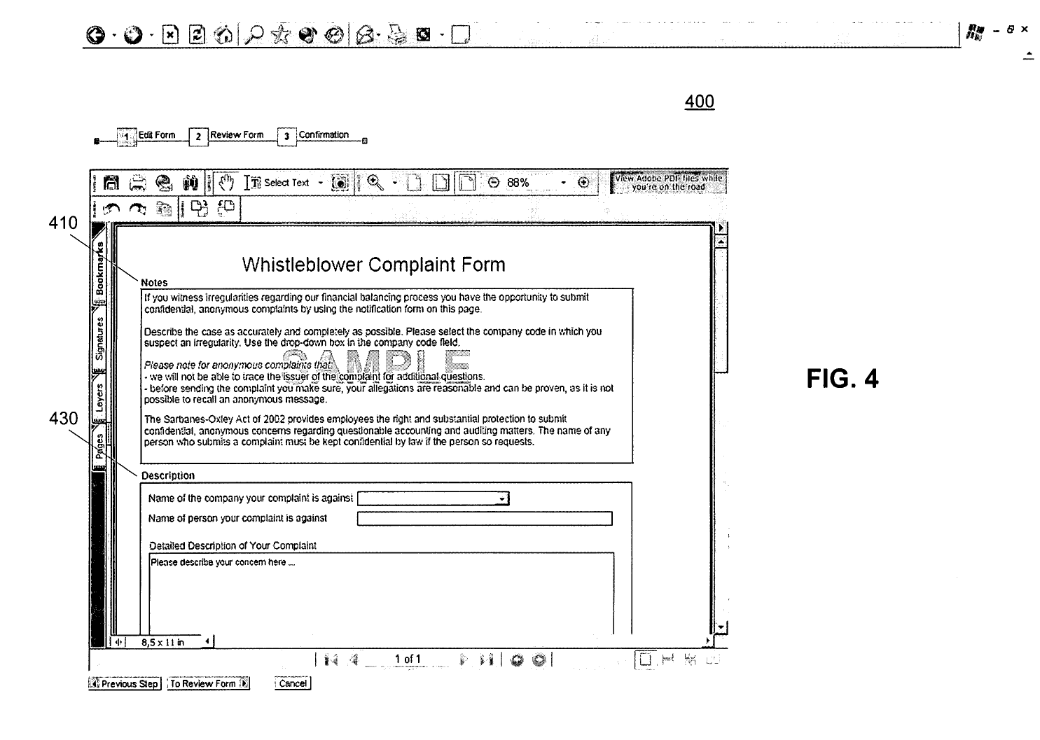

By way of example, FIG. 4 illustrates an exemplary complaint form. In the embodiment of FIG. 4, the complaint form is configured as a whistleblower complaint form 400. The complaint form includes a “Notes” field 410 that may include read-only text with instructions concerning the complaint form and its use. Under Notes field 410, a “Description” field or area 430 may be provided. Area 430 may enable a user to identify the company or business unit and/or the person for which the complaint is launched against. Description area 430 also may include a text entry field (e.g., “Detailed Description of Your Complaint”) for entering a detailed description of the complaint.

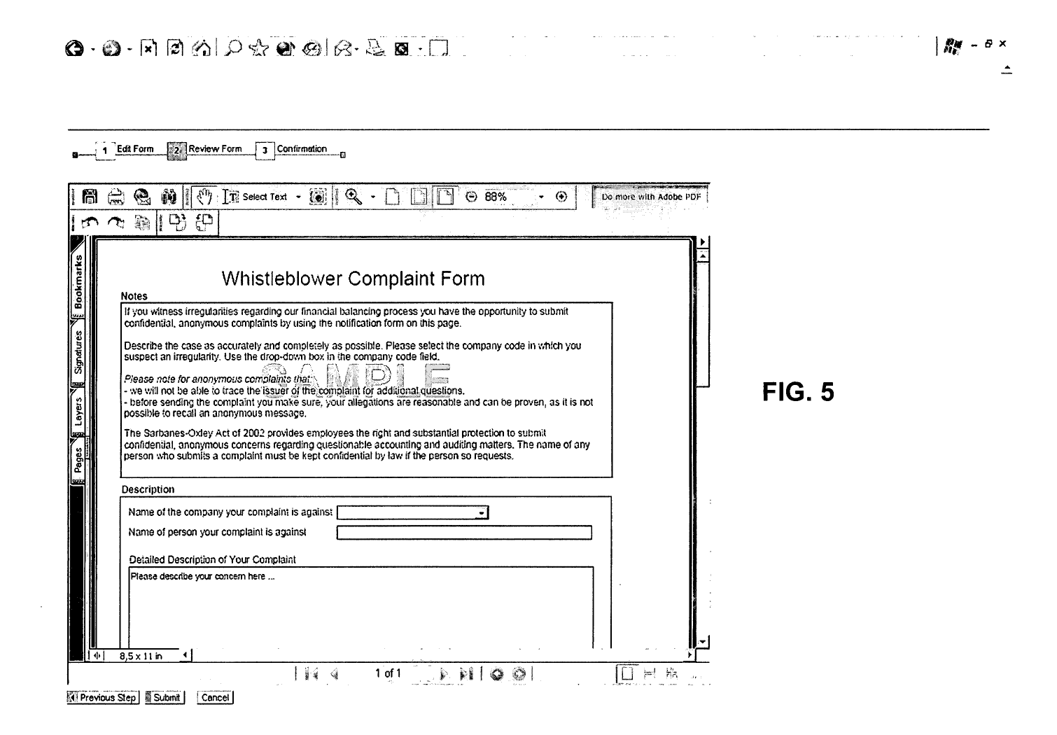

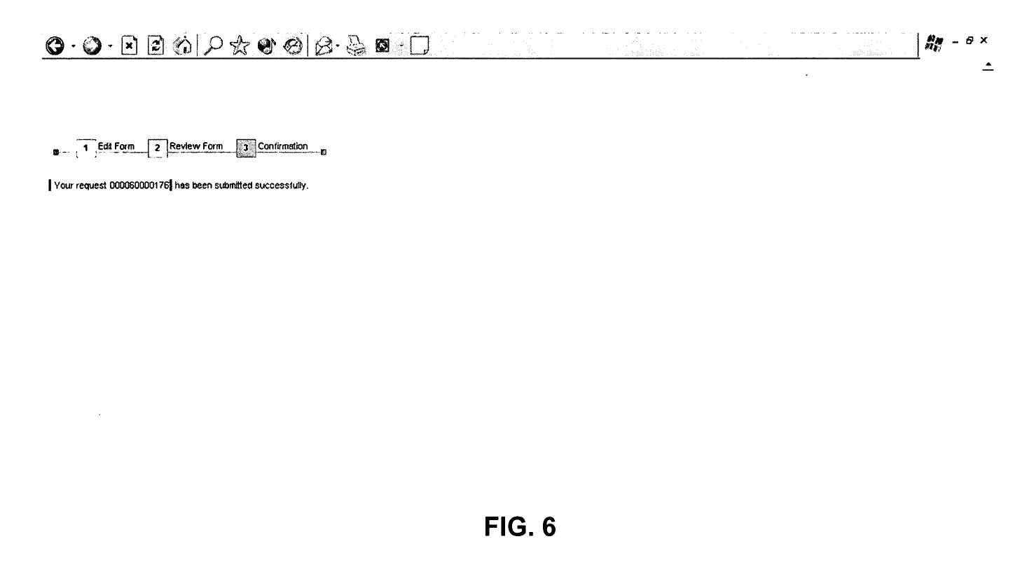

Consistent with embodiments of the invention, an employee or user may first load and display the complaint form in order to edit the form (see, for example, the “1-Edit Form” screen shot of FIG. 4). After completing the form, the employee or user may review the completed complaint form, make final edits (if any) and then submit the same (see, for example, the “2-Review Form” screen shot of FIG. 5). In this regard, a number of action buttons may be provided in the electronic form, such as: (i) a Previous Step button to return the previous page (FIG. 4) and make edits; (ii) a Cancel button to cancel the submission and quit the complaint form; and (iii) a Submit button to submit the completed complaint form. Returning again to FIG. 3, after the second server forwards the complaint information in stage 320, exemplary method 300 may continue to stage 330 where the first server or the second server may provide confirmation to the user or source of the complaint data. The confirmation may be configured to indicate that the complaint was received by the second server. For example, once the complaint form is submitted, a confirmation number or code may be generated and provided to employee (see, for example, the “3-Confirmation” screen shot of FIG. 6). This confirmation code may later be used by the employee to verify that he/she made the submission in order to receive the benefits of, for example, whistle-blower protection measures. After the first or second server provides confirmation data in stage 330, exemplary method 300 may then end at stage 340. Consistent with the invention, a plurality of notification or complaint form entry screens may be provided to permit an employee or user to select a preferred reporting format or method. For example, to submit a report on a business activity, an employee or user may be permitted to select among a plurality of notification screens, including an anonymous notification screen and a notification by named user screen. Thus, consistent with embodiments of the invention, the option to report anonymously or non-anonymously may be provided to the user.

In one embodiment, complaints can be submitted either anonymously or with the user's name. In the case of an anonymous complaint, the complainant does not have to log-on to the corporate or company system with his or her proper user name. The message is automatically posted by the system under an anonymous user. Therefore, it can neither be traced back to the complainant nor stored in the system or shown in the complainant's personal outbox. Once the anonymous complaint is submitted, it is not possible for the complainant to recall it. In case the complainant wishes to submit a complaint under his or her named user, he or she may logon to the system with a personal user ID. The message can then be traced back to the sender and may also be displayed in the complainant's personal inbox.

Embodiments of the invention may be implemented in various system environments and/or may be provided as a module or functionality within a system environment. By way of non-limiting examples, systems and methods consistent with the invention may be implemented as part of the functionality of mySAP™ Financials and/or mySAP™ ERP, available from SAP AG (Walldorf, Germany). In an SAP system environment, anonymous or non-anonymous complaint types may be set up through ISR customizing (transaction qisrscenario, Internet service, and Internet scenario name SR71), by entering the appropriate parameters for “˜LOGIN” and “˜PASSWORD”: (1) for the anonymous user complaints: default user and password; and (2) for the named user complaints: <space> (no entry). If both types of complaint forms are to be used in parallel, then both objects may be copied, the Internet service, which includes the HTML form, and the Internet scenario. Thereafter, customizing for each complaint type may be done as described above.

Consistent with embodiments of the invention, once a complaint is submitted, the complainant may receive a success message with a complaint number or code, as described above. In such a case, the complaint number may be the only documentary evidence of the anonymous complaint. Therefore, the complainant may write it down and keep it in a secure place in order to possibly follow up the matter or to raise a claim on whistleblower protection in case of retaliation (e.g., an SOA Whistleblower Protection Right). The confirmation code may be generated by any system component, such as an Intranet server or an application server, following the submission of a completed complaint form.

Consistent with embodiments of the invention, other forms of confirmation may be provided. For example, a key may be provided to the user that is part of or based on an encryption of an object or document. Such a key may later be used by the complainant to decrypt the object or document (such as an encrypted version of the complaint) and verify that he/she is the author of the complaint.

When the complainant submits a complaint form (e.g., via a “Submit” button), this action may trigger a workflow. For example, the complaint form may be forwarded to the appropriate processor and/or person, as defined in workflow customizing. This person will see the complaint in, for example, his or her personal ISR inbox. Depending on the complaint type, it may include the complainant's name or may be marked as anonymous. In this case, the processor cannot trace the complaint. In addition, to the alert in the processor's personal inbox, the system may automatically send a workflow item. This workflow item can be converted into a regular e-mail if desired.

Further, for embodiments of the invention implemented in a SAP system environment, whistleblower complaint functionality may be provide with R/3 4.6 C or higher. Such embodiments may include an Internet Service Requests (ISR) based on SAP's Internet Transaction Server (ITS) technology. Further, SAP's workflow functionality may manage the entire complaints process. Moreover, if the functionality is provided without a portal, the Internet Transaction Server (ITS) for HTML generation may be used at runtime in order to launch web form(s). In such a case, ITS technology may handle communications between the ISR form and the R/3 system.

Systems and methods, consistent with embodiments of the invention, may be integrated into a business entity's intranet, with the complaint form(s) being available to employees via a URL call. Optionally, in a SAP system environment, the whistleblower functionality may be used within the mySAP™ Enterprise Portal, as ITS-based iView, integrated in any portal role. By way of example, system requirements for such arrangements include: SAP R/3 4.6 C or higher; and Internet Transaction Server (ITS). Additionally, when used in the portal (optional): mySAP™ Enterprise Portal 5.0 and higher; and Integration as ITS-based iView. It is also possible to integrate the functionality into the portal-based Employee Self-Service (ESS) in mySAP™ ERP.

As disclosed herein, embodiments and features of the invention may be implemented through computer-hardware and/or software. Such embodiments may be implemented in various environments, such as networked and computing-based environments with one or more users. The present invention, however, is not limited to such examples, and embodiments of the invention may be implemented with other platforms and in other environments.

By way of example, embodiments of the invention may be implemented using conventional personal computers (PCs), desktops, hand-held devices, multiprocessor computers, pen computers, microprocessor-based or programmable consumer electronics devices, minicomputers, mainframe computers, personal mobile computing devices, mobile phones, portable or stationary personal computers, palmtop computers or the like.

The storage mediums and databases referred to herein symbolize elements that temporarily or permanently store data and instructions. Although storage functions may be provided as part of a computer, memory functions can also be implemented in a network, processors (e.g., cache, register), or elsewhere. While examples of databases have been provided herein, various types of storage mediums can be used to implement features of the invention, such as a read only memory (ROM), a random access memory (RAM), or a memory with other access options. Further, memory functions may be physically implemented by computer-readable media, such as, for example: (a) magnetic media, like a hard disk, a floppy disk, a magnetic disk, a tape, or a cassette tape; (b) optical media, like an optical disk (e.g., a CD-ROM), or a digital versatile disk (DVD); (c) semiconductor media, like DRAM, SRAM, EPROM, EEPROM, memory stick, and/or by any other media, like paper.

Embodiments of the invention may also be embodied in computer program products that are stored in a computer-readable medium or transmitted using a carrier, such as an electronic carrier signal communicated across a network between computers or other devices. In addition to transmitting carrier signals, network environments may be provided to link or connect components in the disclosed systems. Networking environments are commonplace in offices, enterprise-wide computer networks, Intranets and the Internet (i.e., the World Wide Web). The network can be a wired or a wireless network. To name a few network implementations, the network is, for example, a local area network (LAN), a wide area network (WAN), a public switched telephone network (PSTN), an Integrated Services Digital Network (ISDN), an infra-red (IR) link, a radio link, such as a Universal Mobile Telecommunications System (UMTS), Global System for Mobile Communication (GSM), Code Division Multiple Access (CDMA), or a satellite link.

Transmission protocols and data formats are also known, for example, as transmission control protocol/Internet protocol (TCP/IP), hyper text transfer protocol (HTTP), secure HTTP, wireless application protocol, unique resource locator (URL), unique resource identifier (URI), hyper text markup language (HTML), extensible markup language (XML), extensible hyper text markup language (XHTML), wireless application markup language (WML), Standard Generalized Markup Language (SGML), etc. Such features may be utilized to implement embodiments of the present invention, as disclosed herein.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

1. A method for submitting a report on a business activity, the method comprising:
receiving, at a first server, complaint data to identify at least one questioned business activity;
forwarding the complaint data from the first server to a second server, the first server being anonymously logged onto the second server; and
providing confirmation to a source of the complaint data to indicate that the complaint data was received by the second server.

2. The method of claim 1, wherein receiving, at the first server, the complaint data further comprises:
displaying a complaint form on a computing device to a user; and
receiving the complaint data from the complaint form completed and submitted by the user.

3. The method of claim 2, wherein displaying the complaint form further comprises displaying the complaint form comprising:
a read-only text field including instructions from an administrator or auditor, the read-only text field configured to be modified according to specific needs;
a selection field including a drop-down list configured to aid the user in selecting an affected business unit; and
a description field configured to receive data describing details related to the complaint data from the user.

4. The method of claim 1, wherein receiving, at the first server, the complaint data, further comprises receiving the complaint data without the source of the complaint data being identified.

5. The method of claim 1, wherein receiving, at the first server, the complaint data, further comprises receiving the complaint data with the source of the complaint data identified.

6. The method of claim 1, wherein receiving, at the first server, the complaint data further comprises receiving data indicating at least one of irregular accounting practices and auditing procedures.

7. The method of claim 1, wherein receiving, at the first server, the complaint data further comprises receiving data regarding a business entity having stock traded on a stock exchange.

8. The method of claim 1, wherein receiving, at the first server, the complaint data further comprises receiving the complaint data in compliance with at least one of a governmental mandate and a business entity procedure.

9. The method of claim 1, wherein receiving, at the first server, the complaint data further comprises receiving the complaint data from a computing-device comprising one of a self-service kiosk computer, a workstation, a laptop computer, an notebook computer, and a personal digital assistant.

10. The method of claim 1, wherein receiving, at the first server, the complaint data further comprises receiving the complaint data from a computing-device anonymously logged on to the first server, the computing-device comprising one of a self-service kiosk computer, a workstation, a laptop computer, an notebook computer, and a personal digital assistant.

11. The method of claim 1, wherein providing confirmation further comprises providing at least one of a complaint number and a code number.

12. The method of claim 1, wherein providing confirmation further comprises providing a key configured to decrypt an encrypted version of the complaint data.

13. The method of claim 1, wherein providing confirmation further comprises providing confirmation from one of the first server and the second server.

14. The method of claim 1, further comprising reviewing the complaint data from the second server to determine if an investigation should be opened based at least on the complaint data.

15. A system for submitting a report on a business activity, the system comprising:
a memory storage for maintaining a database; and
a processing unit coupled to the memory storage, wherein the processing unit is operative to
receive, at a first server, complaint data to identify at least one questioned business activity;
forward the complaint data from the first server to a second server, the first server being anonymously logged onto the second server; and
provide confirmation to a source of the complaint data to indicate that the complaint data was received by the second server.

16. The system of claim 15, wherein the processing unit being operative to receive, at the first server, the complaint data further comprises the processing unit being operative to:
display a complaint form on a computing device to a user; and
receive the complaint data from the complaint form completed and submitted by the user.

17. The system of claim 16, wherein the processing unit being operative to display the complaint form further comprises the processing unit being operative to display the complaint form comprising:
a read-only text field including instructions from an administrator or auditor, the read-only text field configured to be modified according to specific needs;
a selection field including a drop-down list configured to aid the user in selecting an affected business unit; and
a description field configured to receive data describing details related to the complaint data from the user.

18. The system of claim 15, wherein the processing unit being operative to receive, at the first server, the complaint data, further comprises the processing unit being operative to receive the complaint data without the source of the complaint data being identified.

19. The system of claim 15, wherein the processing unit being operative to receive, at the first server, the complaint data, further comprises the processing unit being operative to receive the complaint data with the source of the complaint data identified.

20. The system of claim 15, wherein the processing unit being operative to receive, at the first server, the complaint data further comprises the processing unit being operative to receive data indicating at least one of irregular accounting practices and auditing procedures.

21. The system of claim 15, wherein the processing unit being operative to receive, at the first server, the complaint data further comprises the processing unit being operative to receive data regarding a business entity having stock traded on a stock exchange.

22. The system of claim 15, wherein the processing unit being operative to receive, at the first server, the complaint data further comprises the processing unit being operative to receive the complaint data in compliance with at least one of a governmental mandate and a business entity procedure.

23. The system of claim 15, wherein the processing unit being operative to receive, at the first server, the complaint data further comprises the processing unit being operative to receive the complaint data from a computing-device comprising one of a self-service kiosk computer, a workstation, a laptop computer, an notebook computer, and a personal digital assistant.

24. The system of claim 15, wherein the processing unit being operative to receive, at the first server, the complaint data further comprises the processing unit being operative to receive the complaint data from a computing-device anonymously logged on to the first server, the computing-device comprising one of a self-service kiosk computer, a workstation, a laptop computer, an notebook computer, and a personal digital assistant.

25. The system of claim 15, wherein the processing unit being operative to provide confirmation further comprises the processing unit being operative to provide at least one of a complaint number and a code number.

26. The system of claim 15, wherein the processing unit being operative to provide confirmation further comprises the processing unit being operative to provide a key configured to decrypt an encrypted version of the complaint data.

27. The system of claim 15, wherein the processing unit being operative to provide confirmation further comprises the processing unit being operative to provide confirmation from one of the first server and the second server.

28. The system of claim 15, wherein the processing unit is further operative to review the complaint data from the second server to determine if an investigation should be opened based at least on the complaint data.

29. A computer-readable medium which stores a set of instructions which when executed performs a method for submitting a report on a business activity, the method by the set of instructions comprising:
receiving, at a first server, complaint data to identify at least one questioned business activity;
forwarding the complaint data from the first server to a second server, the first server being anonymously logged onto the second server; and
providing confirmation to a source of the complaint data to indicate that the complaint data was received by the second server.

30. The computer-readable medium of claim 29, wherein receiving, at the first server, the complaint data further comprises:
displaying a complaint form on a computing device to a user; and
receiving the complaint data from the complaint form completed and submitted by the user.

31. The computer-readable medium of claim 30, wherein displaying the complaint form further comprises displaying the complaint form comprising:
a read-only text field including instructions from an administrator or auditor, the read-only text field configured to be modified according to specific needs;
a selection field including a drop-down list configured to aid the user in selecting an affected business unit; and
a description field configured to receive data describing details related to the complaint data from the user.

32. The computer-readable medium of claim 29, wherein receiving, at the first server, the complaint data, further comprises receiving the complaint data without the source of the complaint data being identified.

33. The computer-readable medium of claim 29, wherein receiving, at the first server, the complaint data, further comprises receiving the complaint data with the source of the complaint data identified.

34. The computer-readable medium of claim 29, wherein receiving, at the first server, the complaint data further comprises receiving data indicating at least one of irregular accounting practices and auditing procedures.

35. The computer-readable medium of claim 29, wherein receiving, at the first server, the complaint data further comprises receiving data regarding a business entity having stock traded on a stock exchange.

36. The computer-readable medium of claim 29, wherein receiving, at the first server, the complaint data further comprises receiving the complaint data in compliance with at least one of a governmental mandate and a business entity procedure.

37. The computer-readable medium of claim 29, wherein receiving, at the first server, the complaint data further comprises receiving the complaint data from a computing-device comprising one of a self-service kiosk computer, a workstation, a laptop computer, an notebook computer, and a personal digital assistant.

38. The computer-readable medium of claim 29, wherein receiving, at the first server, the complaint data further comprises receiving the complaint data from a computing-device anonymously logged on to the first server, the computing-device comprising one of a self-service kiosk computer, a workstation, a laptop computer, an notebook computer, and a personal digital assistant.

39. The computer-readable medium of claim 29, wherein providing confirmation further comprises providing at least one of a complaint number and a code number.

40. The computer-readable medium of claim 29, wherein providing confirmation further comprises providing a key configured to decrypt an encrypted version of the complaint data.

41. The computer-readable medium of claim 29, wherein providing confirmation further comprises providing confirmation from one of the first server and the second server.

42. The computer-readable medium of claim 29, further comprising reviewing the complaint data from the second server to determine if an investigation should be opened based at least on the complaint data.

43. A computerized system for anonymous reporting of business activities, the system comprising:
an application server configured to receive complaint data from a plurality of devices, at least one of the plurality of devices being adapted to be anonymously logged onto the application server,
wherein the complaint data comprises information to identify at least one questioned business activity and further wherein the application server provides confirmation to the at least one device to indicate that the complaint data was received by the application server.

44. The computerized system of claim 43, wherein the plurality of devices comprises at least one of a kiosk and a personal computer device.

45. The computerized system of claim 43, wherein the system further comprises a web server that is anonymously logged onto the application server, and further wherein the application server receives complaint data from at least one of the plurality of devices through the web server, the at least one device being non-anonymously logged onto the web server.

46. The computerized system of claim 43, wherein the application server is further configured for performing logon mapping and forwarding of the complaint data to a database.
